(19) United States
(12) Patent Application Publication
(10) Pub. No.: US 2002/0133391 A1
(43) Pub. Date: Sep. 19, 2002

(54) Marketing systems and methods

(76) Inventor: Timothy Lee Johnson, Niskayuna, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,267

(22) Filed: Mar. 12, 2001

(51) Int. Cl. G06F 17/60

(52) U.S. Cl. 705/10

(57) ABSTRACT

A method and system for on-line marketing to a remote user is disclosed. The method can include performing the following procedures during a session with the user: (i) using a decision rule set to select either one of a plurality of first signals or one of a plurality of second signals, for sending to the display, the one of the plurality of second signals being to solicit information about the user; (ii) measuring a response of the user to the previously selected signal; and (iii) updating the decision rule set in accordance with a probability. The method is capable of selecting a display for the user depending on, for example, a demographic category of the user or on past actions of the user.

### BACKGROUND OF THE INVENTION

This invention relates generally to marketing and, more particularly, to systems and methods of marketing in a computer terminal session.

Commercial web sites operate by displaying product information to consumers, and responding to requests made by consumers during terminal sessions. During a particular terminal session, a consumer may request additional information about a product or class of products. In some cases, the consumer may order a particular product. More frequently, however, the consumer exits the terminal session without ordering a product.

### SUMMARY OF INVENTION

It is therefore desirable to provide marketing systems and methods that increase the probabilities that a consumer will order a product or make other lucrative transactions during a terminal session.

To achieve these and other features of various embodiments of the present invention, there is provided a method for operating with a commercial system having a display for a user. The method includes performing the following procedures during a session with the user: (i) using a decision rule set to select either one of a plurality of first signals or one of a plurality of second signals, for sending to the display, the one of the plurality of second signals being to solicit information about the user; (ii) measuring a response of the user to the previously selected signal; and (iii) updating the decision rule set in accordance with a probability.

According to another feature of an embodiment of the present invention, there is provided a system for operating with a commercial system having a display for a user. The system includes: (i) a decision rule set; (ii) a selector that reads the decision rule set to select either one of a plurality of first signals or one of a plurality of second signals, for sending to the display, the one of the plurality of second signals being to solicit information about the user; (iii) logic that measures a response of the user to the previously selected signal; and (iii) an updater that updates the decision rule set in accordance with a probability.

According to yet another feature of an embodiment of the present invention, there is a system for operating with a commercial system having a display for a user. The system includes: (i) means for using a decision rule set to select either one of a plurality of first signals or one of a plurality of second signals, for sending to the display, the one of the plurality of second signals being to solicit information about the user; (ii) means for measuring a response of the user to the previously selected signal; and (iii) means for updating the decision rule set in accordance with a probability.

According to yet another feature of an embodiment of the present invention, there is provided a computer readable medium bearing computer software instructions for execution by a processor to cause a computer system to perform the following: (i) using a decision rule set to select either one of a plurality of first signals or one of a plurality of second signals, for sending to a display for a user, the one of the plurality of second signals being to solicit information about the user; (ii) measuring a response of the user to the previously selected signal; and (iii) updating the decision rule set in accordance with a probability.

These and other features of various embodiments of the invention will become readily apparent to those skilled in the art upon reading the detailed description that follows.

### BRIEF DESCRIPTION OF DRAWINGS

FIG. 1 is a diagram of circuitry in a system according to a preferred embodiment of the present invention.

FIGS. 2A and 2B represent a flow chart of a process performed by a preferred embodiment.

FIG. 3 is an abstract diagram of a data structure in a preferred embodiment.

FIG. 4 is an example screen display presented to a user.

FIG. 5 is another example screen display presented to a user.

FIG. 6 is another example screen display presented to a user.

FIGS. 7A and 7B represent a diagram of an exemplary session sequence and selection of a next screen display to be presented to the user.

FIG. 8 is an example of a rule set.

FIG. 9 illustrates a recording medium such as an optical CD ROM capable of storing instructions for performing a process of a preferred embodiment.

The accompanying drawings that are incorporated in and that constitute a part of this specification illustrate embodiments of the invention and, together with the description, explain the principles and advantages of the invention. Throughout the drawings, corresponding parts are labeled with corresponding reference numbers.

### DETAILED DESCRIPTION

Embodiments of the present invention relate to methods, systems, and computer readable media useful in, for example, marketing during a computer terminal session. The various embodiments of the invention preferably serve to increase the probabilities of a user ordering a particular product, or making other advantageous transactions during the computer terminal session.

A method of an embodiment of the invention includes performing the following procedures during a session with the user: (i) using a decision rule set to select either one of a plurality of first signals or one of a plurality of second signals, for sending to the display, the one of the plurality of second signals being to solicit information about the user; (ii) measuring a response of the user to the previously selected signal; and (iii) updating the decision rule set in accordance with a probability.

It is preferred in this method that using in procedure (i) includes conditioning selection upon whether certain information is known about the user, or that using in procedure (i) includes conditioning selection upon whether a model has converged. It also is preferred in this embodiment of the invention that an Adaptive Homing Process determines one of the plurality of second signals. In addition, it is preferred that the updating procedure includes updating depending upon a Markov Decision Process. It also is preferred that the updating procedure includes updating depending on whether the user selected a product for purchase.

According to another feature of an embodiment of the present invention, there is provided a system for operating with a commercial system having a display for a user. The system includes: (i) a decision rule set; (ii) a selector that reads the decision rule set to select either one of a plurality of first signals or one of a plurality of second signals, for sending to the display, the one of the plurality of second signals being to solicit information about the user; (iii) logic that measures a response of the user to the previously selected signal; and (iii) an updater that updates the decision rule set in accordance with a probability.

It is preferred that the system further includes a memory that stores demographic information about the user, and that the selector conditions selection responsive to a content of the memory. It also is preferred that the system further includes a model, and that the selector conditions selection depending upon whether the model has converged.

Another preferred feature of the system is that the selector includes a plurality of instructions executable by a processor to perform by an Adaptive Homing Process. It also is preferably that the updater in the system is responsive to a plurality of instructions executable by a processor to perform a Markov Decision Process. In addition, it is preferred that the updater of the system is responsive to whether the user selected a product for purchase.

According to yet another feature of an embodiment of the present invention, there is a system for operating with a commercial system having a display for a user. The system includes: (i) means for using a decision rule set to select either one of a plurality of first signals or one of a plurality of second signals, for sending to the display, the one of the plurality of second signals being to solicit information about the user; (ii) means for measuring a response of the user to the previously selected signal; and (iii) means for updating the decision rule set in accordance with a probability.

It is preferred that the means for using in the system includes means for conditioning selection upon whether certain information is known about the user, and/or that the means for using in the system includes means for conditioning selection upon whether a model has converged. It also is preferred that the means for updating in the system updating depending upon a Markov Decision Process. In addition, it is preferred that the means for updating includes updating depending on whether the user selected a product for purchase.

According to yet another feature of an embodiment of the present invention, there is provided a computer readable medium bearing computer software instructions for execution by a processor to cause a computer system to perform the following: (i) using a decision rule set to select either one of a plurality of first signals or one of a plurality of second signals, for sending to a display for a user, the one of the plurality of second signals being to solicit information about the user; (ii) measuring a response of the user to the previously selected signal; and (iii) updating the decision rule set in accordance with a probability.

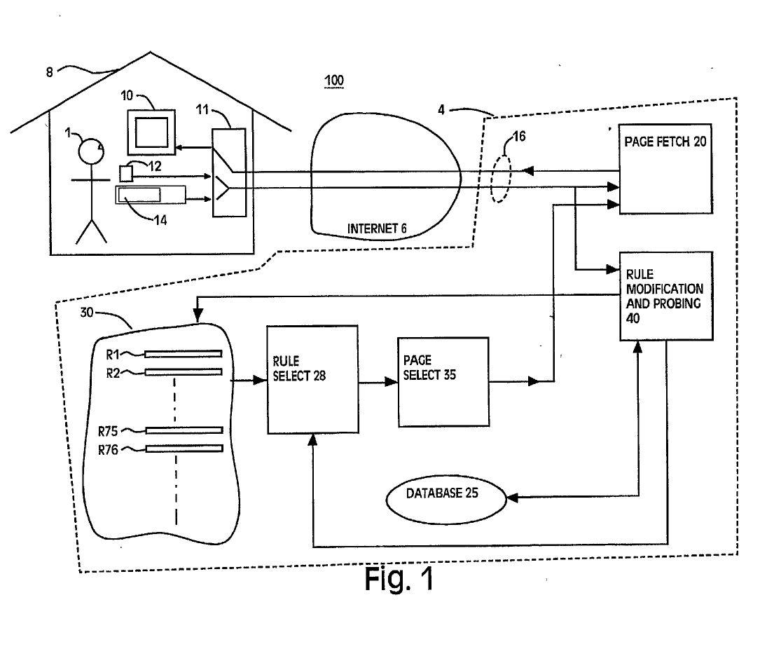

Referring now to the drawings, FIG. 1 illustrates data paths in system 100 in accordance with a preferred embodiment of the present invention. Retail center 4 includes circuitry that presents product information to user 1 in home 8, via Internet 6. Retail center 4 also includes circuitry to perform a purchase transaction with user 1. In this Disclosure, the term circuitry encompasses both dedicated hardware and programmable hardware, such as a CPU or reconfigurable logic array, in combination with programming data, such as sequentially fetched CPU instructions or programming data for a reconfigurable logic array.

The circuitry in center 4 preferably includes a general purpose personal computer processor executing instructions in a random access memory, nonvolatile disk storage, and telecommunications hardware.

User 1 preferably is a prospective customer of retail center 4. First, user 1 manipulates mouse input device 12 or keyboard 14, causing center 4 to establish Transport Control Protocol (TCP) connection 16. Page fetch processor 20 sends a web page, in the form of a HyperText Markup Language (HTML), Extensible Markup Language (XML) document, or the like, to home 8. Local circuitry 11 receives the web page from Internet 6 and displays the web page on CRT display 10. Local circuitry 11 includes a general purpose personal computer processor executing instructions in a random access memory, non-volatile disk storage, and telecommunications hardware such as a modem.

In response to viewing the web page on CRT display 10, user 1 uses mouse 12 or keyboard 14 to send information to center 4. This information sent to center 4 may explicitly include demographic information, such as the gender or income of user 1, or may include an identifier allowing center 4 to read a record containing demographic and behavior information stored in database 25. Database 25 includes a priori information about a particular user or a type of user.

After viewing web pages, user 1 uses mouse input device 12 or keyboard 14 to order a product or to exit without ordering a product in this session. If the user exits, (s)he may later initiate another session, possibly culminating in an order.

Depending on a state of a session with user 1, rule select processor 28 selects one of the rules from rule set 30. A rule is logic for deciding which web page to next display to the user. Thus, each rule in set 30 dictates a particular page to be displayed to a user to maximize the chance of homing in on a lucrative sale closure with the user.

Page select processor 35 receives a particular rule from set 30, via rule select processor 28, and uses the rule to select a web page for sending to user 1 in home 8. Page select processor 35 operates by selecting a web page associated with a starting node in the received rule from set 30.

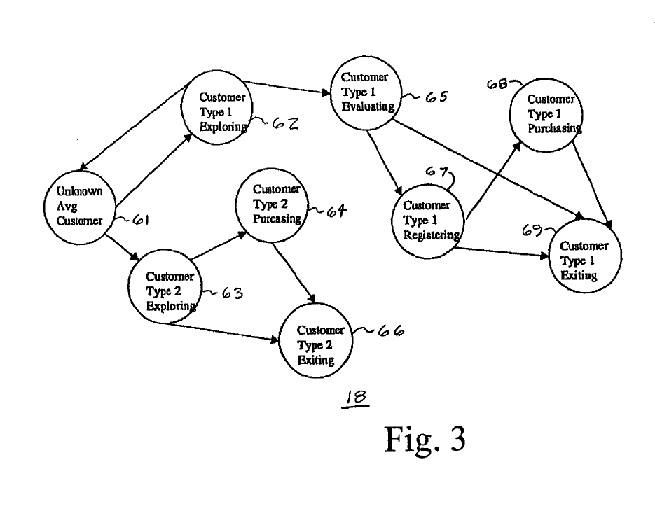

Modification processor 40 receives user action. Modification processor 40 uses this received action information to update a “model” of customer behavior (FIG. 3). Each “model” of the preferred embodiment is a state transition diagram. These model probabilities reflect estimates of how a particular class of users will behave.

Modification processor 40 also uses this received action information to update database 25. Database 25 includes information about a particular user. This user information includes demographic category information and a record of how the particular user behaved during previous terminal sessions. At any time, database 25 for a particular customer will contain: (1) what demographic category he/she is in (if known—this affects what state model will be used); (2) a record of previous system decisions and prior actions of the customer during prior sessions, along with the best estimate of the customer's node transition probabilities, some of which may be initially unknown if the customer has not yet visited all nodes in prior sessions; (3) an initial state estimate for the customer as they initiate the current session.

In a subsequent session with user 1 or a person having similar demographics, page select processor 35 uses database 25 to select an initial rule from set 30, thereby dictating the selection of a candidate page for sending to the user.

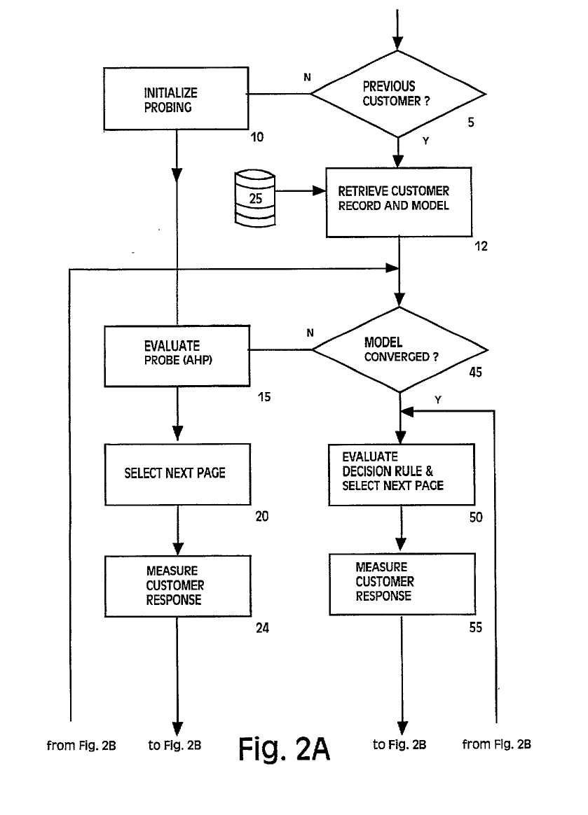

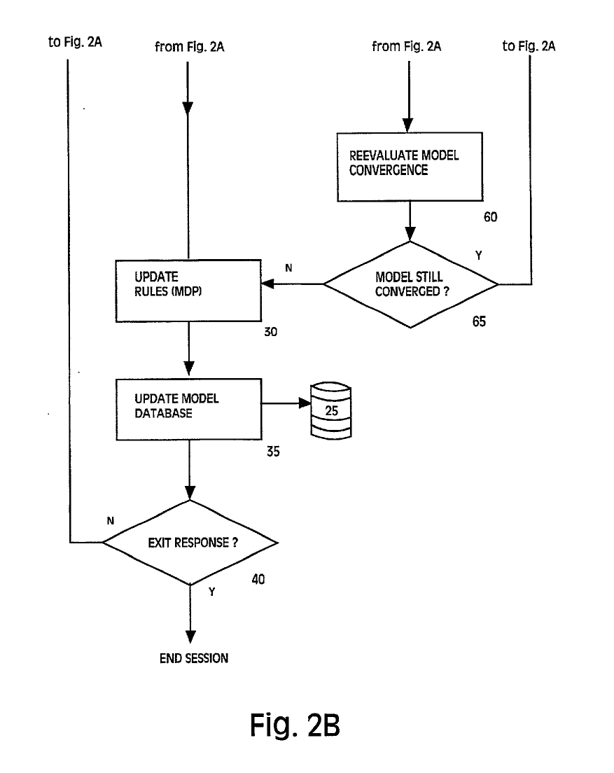

FIGS. 2A and 2B show a flow chart of a process performed by the general purpose personal computer processor, executing instructions, in center 4, at one or more decision points during a terminal session. Center 4 determines whether the user has been previously identified (Step 5). If the user has not been previously identified, center 4 initializes probing to learn more information about the user. (Step 10). Center 4 evaluates the probing process (Step 15). Center 4 evaluates the probing process and performs an Adaptive Homing Process (Step 15). In step 15, Evaluate Probe is the process of selecting a next page (HTML) for display to the customer to provide the most information to the Retail Center concerning the present state of the customer's knowledge of the product and/or purchasing intentions, based on prior knowledge of the customer's demographic information (based on customer data base) and behavior during prior sessions or earlier in the current session. For example, the page may display information or questions to help identify which situation in FIG. 3 best defines the customer's set of knowledge. The Adaptive Homing Process is an application of the Adaptive Homing Algorithm to the present problem, which computes successive inputs (HTML page selections), based on the customer's prior responses during the present session, which allows the retail center to deduce the customer's current state from a minimum number of display-response steps. A suitable Adaptive Homing Algorithm is described in Hennie, Fred C., Finite-State Models for Logical Machines, John Wiley & Sons. Inc. New York, 1968, the contents of which are herein incorporated by reference in their entirety; and Hennie, Fred C., “Fault Detecting Experiments for Sequential Circuits”, Proc. 5^{th} Ann. Symp. Switching Circuit Theory and Logical Design, pp. 95-110, Princeton, N.J., November 1964, the contents of which are herein incorporated by reference in their entirety.

This process operates by successively reducing the possible subset of states (e.g., in FIG. 3) which the customer may currently be in, given his past selections. The process will either converge to a specific state ( i.e., a single state in FIG. 3) or a smallest subset of the total number of possible states in a minimal number of interactions. Once this process is complete, the model is updated (via successive iterations of the steps 15, 20, and 24 during succeeding customer responses) with the current state of the customer being known, and the decision rules can be applied at the time of the next response (Step 50), or the model can be updated (Steps 30, 35) to include new and previously unknown states of the customer's behavior.

Center 4 selects and displays a page to the user (Step 20). Center 4 measures the customer's response to the page displayed in step 20. (Step 24). In response to measuring the customer response, center 4 updates the rules using a Markov Decision Process (MDP). (Step 30). In step 30, Markov Decision Process is the name of the process for updating the model, and for updating the rule set (at the same time); the rule set (obtained via stochastic dynamic programming, via an algorithm termed policy iteration) will define an optimal Markov Decision Process. The model itself is a Markov Process or Markov Chain. The Markov Decision Process is described in Puterman, Martin L., Markov Decision Processes, John Wiley & Sons, New York, 1994 (Ch. 6), the contents of which are herein incorporated by reference in their entirety.

Center 4 updates the customer model by writing to database 25 (Step 35). If the user selects a link or button indicating the user wishes to exit, center 4 ends the session. (Step 40). Otherwise, control passes to step 45.

In step 45, center 4 determines whether the customer model is converged. The customer model is converged if the current parameters of the model are sufficiently close to the previous set of parameters. The parameters of a model include the particular states in the model and the particular arcs between states. Arcs between states may correspond to the user selecting a link to go from one web page to another.

Center 4 evaluates a decision rule (Step 50). Center 4 measures the user's response (Step 55). In this example, the user's response is which selection he made in response to a new HTML page.

Center 4 reevaluates model convergence (Step 60). If the user model is still converged (Step 65), control passes to step 50. Otherwise, control passes to step 30.

If at the beginning of the session the user is identified as a previous user (Step 5), center 4 retrieves the customers record and user model from database 25 (Step 12) and control passes to step 45.

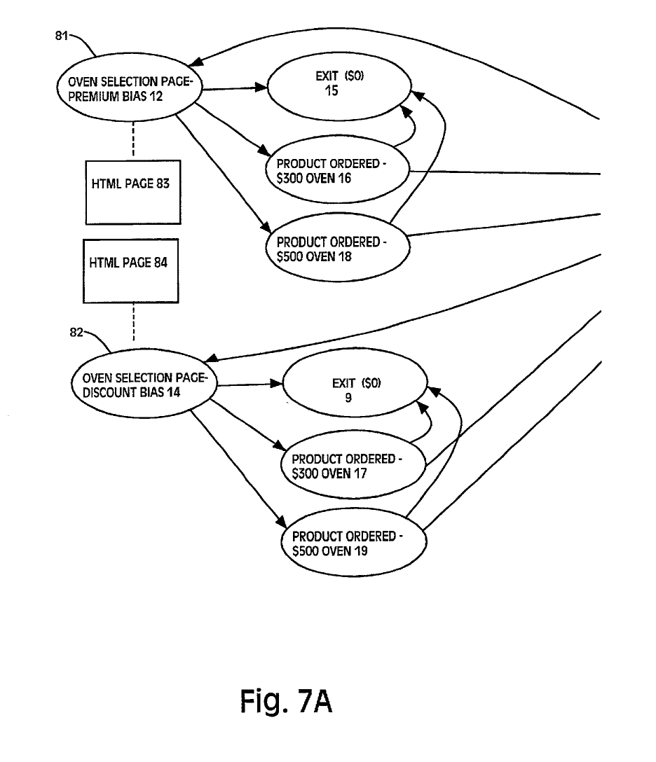

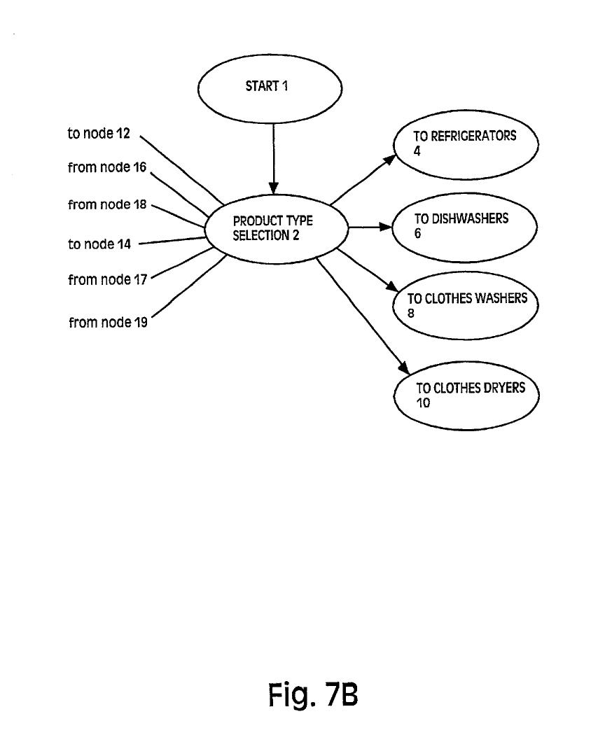

FIG. 3 shows a data structure 1 8 stored in database 25. Data structure 18 reflects a customer Markov model. The transitions out of node 61 represent the result from displaying a probing page and receiving more information about the user. In FIG. 3, “type 1” may designate, for example, a customer biased towards buying discount items, and “type 2” may designate, for example, a customer biased towards buying premium items. The transition from node 62 back to node 61 represents a possibility that a customer tentatively identified as type 1 will make a selection inconsistent with that of a true type 1 customer, requiring that the customer once again be placed into the broader “unknown” category. FIGS. 7A and 7B, described below, show how the rules dynamically update the next page based on the customer type.

Transitions out of each of nodes 62, 63, 64, 65, 66, 67, 68, and 69 are assumed to have fixed but initially unknown probabilities of occurring. System 100 determines the probabilities empirically based on customer behavior. In other words, system 100 initially assigns probabilities for a customer based on all prior information about the customer type, and updates (improves) the probabilities in the course of a session, based on the customer's measured actions. (See 35 step in FIG. 2B)

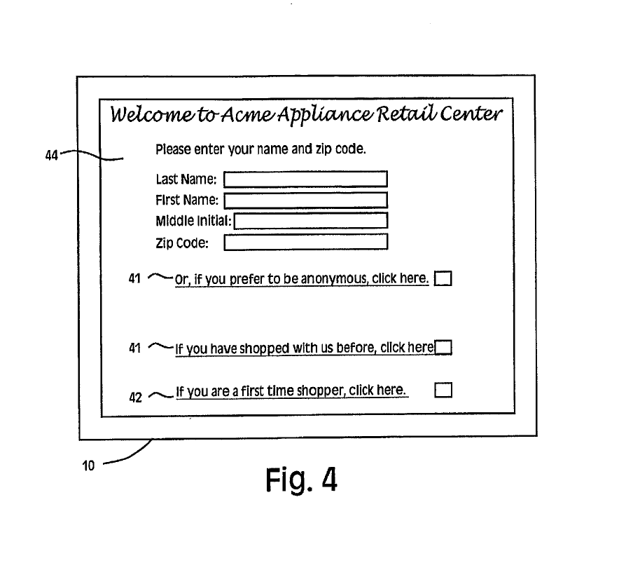

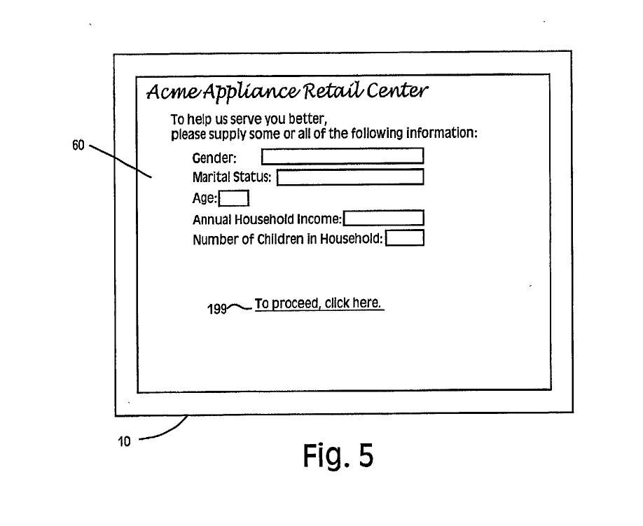

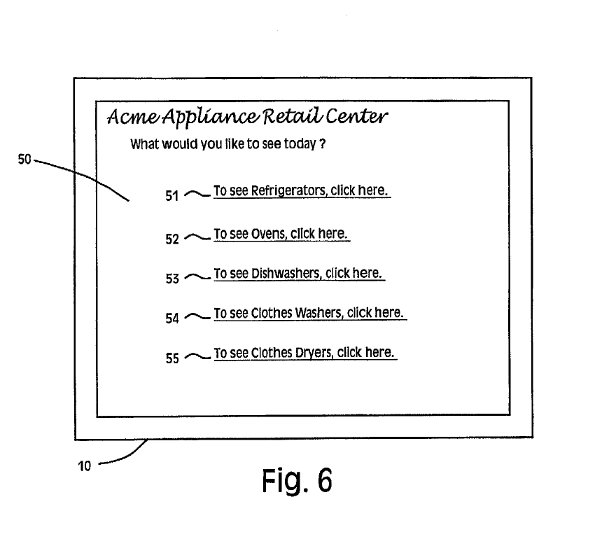

FIG. 4 shows an initial screen that page fetch processor 20 causes to be sent to CRT display 10. FIG. 4 shows an example of a customer registering page. A person may identify herself/himself by filling in the name and zip code information screen fields 44. Filling in fields 44 is an example of “registering” shown in node 67 of FIG. 3. Next, if the person selects link 41, indicating that (s)he prefers to be anonymous, and/or indicating that (s)he has shopped with Acme before, page fetch processor 20 causes page 50, shown in FIG. 6, to be sent to CRT display 10. Alternately, if the user selects link 42, indicating that it is her/his first time shopping with Acme, page fetch processor 20 causes page 60, shown in FIG. 5, to be sent to CRT display 10.

As shown in FIG. 5, page 60 is a page useful for collecting demographic information about the user at the beginning of the session. FIG. 5 shows an example of a customer exploring page as shown in nodes 62 and 63 of FIG. 3. After displaying page 60, page fetch processor 20 causes page 50 (FIG. 6) to be displayed on CRT display 10. FIG. 6 shows an example of a customer evaluating page as shown in node 65 of FIG. 3.

Referring now to FIGS. 1 and 6, each of links 51, 52, 53, 54, or 55 corresponds to a respective decision point at which center 4 executes the steps of FIGS. 2A and 2B.

FIGS. 7A and 7B correspond to link 52 for ovens. FIGS. 7A and 7B show a set of possible execution sequences, or “sample paths,” of a model such as that in FIG. 3. In FIGS. 7A and 7B, each solid line represents a state transition. Each state in FIGS. 7A and 7B has a probability of visitation. Page select processor 35 (FIG. 1) selects the starting node to be either a prespecified “reset” state (FIG. 3, item 61) or another state determined via the adaptive homing process (AHP), in the case where there was no prior known model. The expected revenue at the starting node would be the average revenue expected from an otherwise unknown customer. For clarity, details and many of the state transitions have been omitted from FIGS. 7A and 7B.

After page select processor selects one of nodes 81 or 82 as the candidate starting node, the page select processor 35 (FIG. 1) calculates the probability of the user exiting if the HTML page associated with the candidate starting node is sent as the next page for display to the user.

At any point during a session, system 100 knows what page the customer is viewing, and hence is only concerned with optimizing the results of her/his next action. If a customer returns to a node several times from one or more pages, this increases her/his (a posteriori) probability of visiting that node (FIG. 2B, step 60), and hence will favor policies that cause her/him to either exit or increase the likelihood of purchase. If appropriate web pages are lacking, however, certain features of a customer's behavior may not be distinguishable via his or her web page selections. For example, if the designer of the system did not include a page with answers to the “most important questions” that a buyer uses to make a selection, a result could be lower sales and less ability to distinguish likely from unlikely buyers, even though the schema of FIGS. 2A and 2B applies. In these cases of a suboptimal system, there will be more probing action, given the set of web pages chosen by the designer, that can distinguish these classes of buyers based on their behavior. The “homing process” used in this probing may converge statistically to a set of nodes and not a single node, and the best achievable performance of the system may be lower than that of a more optimally designed system.

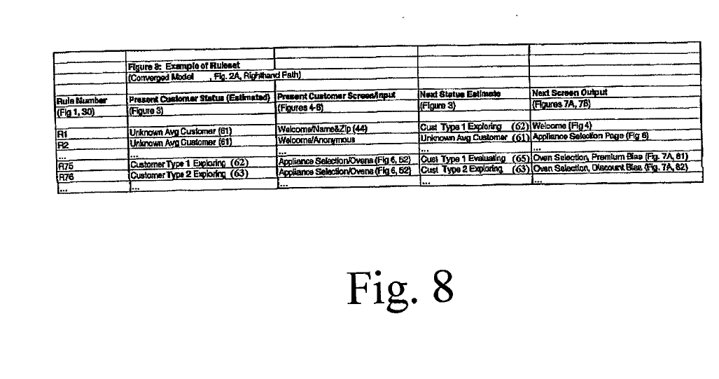

FIG. 8 illustrates rules 30 (FIG. 1) governing the transitions between states, based on the customer Markov modeling. In FIG. 8, each row represents a rule.

Although the exemplary system 100 (FIG. 1) shows attribute information received from user input devices 12 or 14, more detailed attribute information could also be received for a user via a more automatic procedure such as the reading of a “cookie” stored on the user's personal computer.

A starting node in a rule could correspond to a respective product different from that of other starting nodes. Alternately, starting nodes in a rule could correspond to the same product with a different presentation depending on the node. For example, if it is believed that a black oven may be more appealing to males, a particular starting node for a particular model of oven for a male user may have an associated page displaying a black submodel of the oven. In a similar vein, a corresponding starting node in a rule for a female user may have a corresponding page displaying a white submodel of the oven.

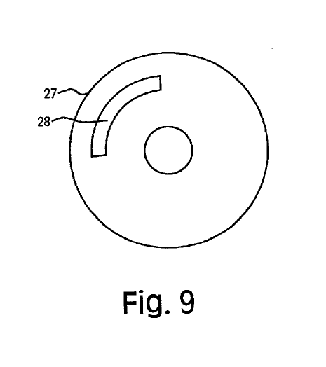

FIG. 9 illustrates a compact, or optical disk, a read only memory (CD ROM) 28, or the like, that stores instructions 27. A processor executing instructions 27 will perform the process of FIGS. 2A and 2B described above.

Additional advantages and modifications will be readily apparent to those skilled in the art. The invention in its broader aspects is therefore not limited to the specific details, representative apparatus, and illustrative examples shown and described. Accordingly, departures may be made from such details without departing from the spirit or the scope of the general inventive concept described herein. The invention is defined in the following claims. In general, the words “first,” “second,” etc., employed in the claims do not necessarily denote an order.

1. A method for operating with a commercial system having a display for a user, the method comprising performing the following procedures during a session with the user:
using a decision rule set to select either one of a plurality of first signals or one of a plurality of second signals, for sending to the display, the one of the plurality of second signals being to solicit information about the user;
measuring a response of the user to the previously selected signal; and updating the decision rule set in accordance with a probability.

2. The method of claim 1, wherein using includes conditioning selection upon whether certain information is known about the user.

3. The method of claim 1, wherein using includes conditioning selection upon whether a model has converged.

4. The method of claim 1, wherein the one of the plurality of second signals is determined by an Adaptive Homing Process.

5. The method of claim 1, wherein updating includes updating depending upon a Markov Decision Process.

6. The method of claim 1, wherein updating includes updating depending on whether the user selected a product for purchase.

7. A system for operating with a commercial system having a display for a user, the system comprising:
a decision rule set;
a selector that reads the decision rule set to select either one of a plurality of first signals or one of a plurality of second signals, for sending to the display, the one of the plurality of second signals being to solicit information about the user;
logic that measures a response of the user to the previously selected signal; and
an updater that updates the decision rule set in accordance with a probability.

8. The system of claim 7, further comprising a memory that stores demographic information about the user, wherein the selector conditions selection responsive to a content of the memory.

9. The system of claim 7, further comprising a model, wherein the selector conditions selection depending upon whether the model has converged.

10. The system of claim 7, wherein the selector includes a plurality of instructions executable by a processor to perform by an Adaptive Homing Process.

11. The system of claim 7, wherein the updater is responsive to a plurality of instructions executable by a processor to perform a Markov Decision Process.

12. The system of claim 7, wherein the updater is responsive to whether the user selected a product for purchase.

13. A system for operating with a commercial system having a display for a user, the system comprising:
means for using a decision rule set to select either one of a plurality of first signals or one of a plurality of second signals, for sending to the display, the one of the plurality of second signals being to solicit information about the user;
means for measuring a response of the user to the previously selected signal; and
means for updating the decision rule set in accordance with a probability.

14. The system of claim 13, wherein means for using comprises means for conditioning selection upon whether certain information is known about the user.

15. The system of claim 13, wherein means for using comprises means for conditioning selection upon whether a model has converged.

16. The system of claim 13, wherein means for updating includes updating depending upon a Markov Decision Process.

17. The system of claim 13, wherein means for updating includes updating depending on whether the user selected a product for purchase.

18. A computer readable medium bearing computer software instructions for execution by a processor to cause a computer system to perform:
using a decision rule set to select either one of a plurality of first signals or one of a plurality of second signals, for sending to a display for a user, the one of the plurality of second signals being to solicit information about the user;
measuring a response of the user to the previously selected signal; and updating the decision rule set in accordance with a probability.
